(19) United States
(12) Patent Application Publication
(10) Pub. No.: US 2025/0206619 A1
(43) Pub. Date: Jun. 26, 2025

(54) GRAPHITIC CARBON SEPARATION AND PURIFICATION

(71) Applicant: Maple Materials, Inc., Richmond, CA (US)

(72) Inventors: Niklas Johann Caspar Mundhenk, Richmond, CA (US); Drew Lawrence Reid, San Rafael, CA (US); Kevin Yu, Berkeley, CA (US)

(21) Appl. No.: 18/987,644

(22) Filed: Dec. 19, 2024

Related U.S. Application Data
(60) Provisional application No. 63/612,979, filed on Dec. 20, 2023.

(51) Int. Cl. C01B 32/215; B01D 21/00; C01D 7/12; C01D 15/08; C25B 1/135; C25B 1/14; C25B 9/09; H01M 10/54

(52) U.S. Cl. CPC C01B 32/215; B01D 21/0084; C01D 7/12; C01D 15/08; C25B 1/135; C25B 1/14; C25B 9/09; H01M 10/54

(57) ABSTRACT

The embodiments herein relate to methods, apparatus, and systems for forming and purifying solid carbon material from a molten carbonate salt electrolyte or spent lithium-ion batteries. Various embodiments also provide methods, apparatus, and systems for recycling certain materials including the carbonate salt electrolyte, carbon dioxide, water, etc. The system utilizes carbon dioxide in one or more processes, for example to purify the solid carbon and regenerate the carbonate salt electrolyte. These methods, apparatus, and systems may also employ a froth separator and/or heatless precipitation reactor to consume carbon dioxide in the production of solid carbon.

### CROSS-REFERENCES

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Graphite is a form of crystalline carbon. The carbon atoms within graphite are densely arranged in parallel-stacked, planar, honeycomb-lattice sheets. Graphite is a soft mineral which exhibits perfect basal cleavage. It is flexible but not elastic, has a low specific gravity, is highly refractory, and has a melting point of 3,927° C. Of the non-metals, graphite is the most thermally and electrically conductive, and it is chemically inert. These properties make graphite beneficial for numerous applications in a range of fields. Worldwide demand for graphite and other solid forms of carbon has increased in recent years, and is expected to continue to increase as global economic conditions improve and further applications are developed.

Some examples of the uses of graphite and other forms of solid carbon include use as a steel component, static and dynamic seals, low-current, long-life batteries (particularly lithium ion batteries), rubber, powder metallurgy, porosity-enhancing inert fillers, valve and stem packing, and solid carbon shapes. Graphite is also used in the manufacture of supercapacitors and ultracapacitors, catalyst supports, antistatic plastics, electromagnetic interference shielding, electrostatic paint and powder coatings, conductive plastics and rubbers, high-voltage power cable conductive shields, semiconductive cable compounds, and membrane switches and resistors. In some cases, solid carbon may be used to form various materials including, but not limited to, polymer composites, metal matrix composites, carbon-carbon composites, ceramic composites, and combinations thereof.

In recent years, graphite and other forms of solid carbon have been important in the emerging non-carbon energy sector, and they have been used in several new energy applications such as in pebbles for modular nuclear reactors and in high-strength composites for wind, tide and wave turbines. Solid carbon has also been used in energy storage applications such as bipolar plates for fuel cells and flow batteries, anodes for lithium-ion batteries, electrodes for supercapacitors, phase change heat storage, solar boilers, and high-strength composites for flywheels. Furthermore, graphite is used in energy management applications such as high-performance polystyrene thermal insulation and silicon heat dissipation.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect involves a separator including: a vessel including a gas sparger; a first inlet configured to receive a mixture of an aqueous solution of one or more lithium compounds and a solid carbon material; a first outlet configured to transport a froth including the solid carbon material from the vessel to a collector; and a second outlet configured to transport the aqueous solution out of the vessel.

In various embodiments, the vessel further includes an agitator.

In various embodiments, the solid carbon material includes graphite.

In various embodiments, the aqueous solution includes lithium bicarbonate.

In various embodiments, the mixture of the aqueous solution and the solid carbon material includes one or more solid impurities, and the separator includes a filter configured to (a) receive the aqueous solution and solid impurities from the second outlet, and (b) filter the solid impurities from the aqueous solution.

Another aspect involves a method including: receiving a mixture of an aqueous solution of one or more lithium compounds and solid carbon material; forming a froth on the mixture, such that the froth includes the solid carbon material; and separating the solid carbon material from the froth.

In various embodiments, the solid carbon material includes graphite.

In various embodiments, the aqueous solution includes lithium bicarbonate.

In various embodiments, the froth is formed by introducing a gas and/or agitating the mixture.

In various embodiments, the mixture of the aqueous solution and the solid carbon material includes one or more solid impurities, and the method also includes filtering the one or more solid impurities from the mixture of the aqueous solution.

Another aspect involves a system including: (a) a grinder configured to grind a solid mixture of lithium carbonate, lithium oxide, and a solid carbon material to form a ground solid mixture; (b) an aqueous lithium compound generator configured to (i) receive the ground solid mixture produced by the grinder, and (ii) output a mixture of an aqueous solution of one or more lithium compounds and the solid carbon material; and (c) a froth separator configured to (i) receive the mixture of the aqueous solution of the one or more lithium compounds and the solid carbon material, and (ii) output a froth including the solid carbon material.

In various embodiments, the solid carbon material includes graphite.

In various embodiments, the aqueous solution includes lithium bicarbonate.

In various embodiments, the froth separator further includes an agitator and/or a gas sparger.

In various embodiments, the mixture of the aqueous solution and the solid carbon material includes one or more solid impurities, and such that the froth separator includes a filter configured to (a) receive the mixture including the one or more solid impurities, and (b) filter the one or more solid impurities from the aqueous solution.

Another aspect involves a method including: mixing an aqueous solution of lithium hydroxide and an aqueous solution of lithium bicarbonate; adjusting and/or maintaining an aqueous solution produced by the mixing at a pH of about 11.8; and removing a lithium carbonate precipitate formed by a reaction between the lithium hydroxide and the lithium bicarbonate.

In various embodiments, the method also includes providing the lithium carbonate to an electrolysis reactor. In some embodiments, the lithium carbonate in the electrolysis reactor is molten lithium carbonate.

In various embodiments, the method also includes reacting lithium oxide with water to produce the aqueous solution of the lithium hydroxide.

In various embodiments, the method also includes reacting lithium carbonate with water and carbon dioxide to produce the aqueous solution of the lithium bicarbonate.

In various embodiments, the method also includes removing particles of a carbon material from the aqueous solution of lithium bicarbonate prior to mixing the aqueous solution of lithium bicarbonate with the aqueous solution of lithium hydroxide.

Another aspect involves a system including: (a) a lithium hydroxide separator configured to (i) receive a mixture of a solid carbon material, lithium carbonate, and lithium oxide, (ii) output an aqueous lithium hydroxide solution, and (iii) output a first mixture of lithium carbonate and the solid carbon material; (b) a pressurizable carbonation reactor configured to receive the first mixture of lithium carbonate and the solid carbon material, and (ii) output a second mixture of aqueous lithium bicarbonate solution and the solid carbon material; and (d) a precipitation reactor configured to receive the aqueous lithium bicarbonate solution and the aqueous lithium hydroxide solution and produce a precipitate of lithium carbonate.

In various embodiments, the system further includes an electrolysis reactor.

In various embodiments, the system further includes a filter configured to remove particles of a carbon material from the aqueous lithium bicarbonate solution prior to mixing the aqueous lithium bicarbonate solution with the aqueous lithium hydroxide solution.

Another aspect involves a method including: (a) contacting water with a first ground solid mixture of a solid carbon material, lithium carbonate, and lithium oxide and producing (i) a first output including an aqueous lithium hydroxide solution, and (ii) a second output including a second mixture of lithium carbonate and the solid carbon material; (b) reacting the second mixture of lithium carbonate and the solid carbon material at elevated CO₂ pressure to produce a third mixture of aqueous lithium bicarbonate solution and the solid carbon material; (c) forming a froth on the third mixture of the aqueous lithium bicarbonate solution and the solid carbon material, such that the froth includes the solid carbon material; and (d) mixing the aqueous lithium bicarbonate solution and the aqueous lithium hydroxide solution and producing a precipitate of lithium carbonate.

In various embodiments, the method also includes prior to contacting water with the first ground solid mixture, (i) receiving carbon dioxide and lithium carbonate, and (b) producing an unground solid mixture of the solid carbon material, the lithium carbonate, and the lithium oxide using an electrolysis reactor.

In various embodiments, the electrolysis reactor is configured to electrochemically reduce molten lithium carbonate.

In various embodiments, the method also includes recycling purified lithium carbonate to the electrolysis reactor.

In various embodiments, the first ground solid mixture of the solid carbon material, the lithium carbonate, and the lithium oxide includes spent lithium battery intercalation anodes.

In various embodiments, the method also includes grinding to produce the first ground solid mixture of the solid carbon material, the lithium carbonate, and the lithium oxide.

In various embodiments, the method also includes reacting carbon dioxide and water with the lithium carbonate to produce the aqueous lithium bicarbonate solution.

In various embodiments, the method also includes receiving carbon dioxide and maintaining an aqueous composition within a precipitation reactor at a pH of about 11.8.

Another aspect involves a system including: (a) a lithium hydroxide separator configured to (i) receive a ground solid mixture of a solid carbon material, lithium carbonate, and lithium oxide, (ii) output an aqueous lithium hydroxide solution, and (iii) output a first mixture of lithium carbonate and the solid carbon material; (b) a pressurizable carbonation reactor configured to receive the first mixture of lithium carbonate and the solid carbon material, and (ii) output a second mixture of aqueous lithium bicarbonate solution and the solid carbon material; (c) a froth floatation separator configured to (i) receive the second mixture of aqueous lithium bicarbonate solution and the solid carbon material, and (ii) output a froth including the solid carbon material; and (d) a precipitation reactor configured to receive the aqueous lithium bicarbonate solution and the aqueous lithium hydroxide solution and, from these, produce a precipitate of lithium carbonate.

In various embodiments, the system also includes an electrolysis reactor configured to (i) receive carbon dioxide and/or lithium carbonate, and (b) produce an unground solid mixture of the solid carbon material, the lithium carbonate, and the lithium oxide.

In various embodiments, the electrolysis reactor is configured to electrochemically reduce molten lithium carbonate.

In various embodiments, the system also includes recycling purified lithium carbonate to the electrolysis reactor.

In various embodiments, the ground solid mixture of the solid carbon material, lithium carbonate, and lithium oxide includes spent lithium battery intercalation anodes.

In various embodiments, the system also includes a grinder configured to produce the ground solid mixture of the solid carbon material, the lithium carbonate, and the lithium oxide.

In some embodiments, the pressurizable carbonation reactor is further configured to receive carbon dioxide and water that react with the lithium carbonate to produce the aqueous lithium bicarbonate solution.

In some embodiments, the precipitation reactor is further configured to receive carbon dioxide and maintain an aqueous composition within the precipitation reactor at a pH of about 11.8.

These and other aspects are described further below with reference to the drawings.

### BRIEF DESCRIPTION OF THE DRAWINGS

FIG. 1 is a flowchart describing a method of generating and purifying solid carbon according to certain embodiments.

FIG. 2 is a block diagram illustrating a system for generating and purifying solid carbon according to certain embodiments.

FIG. 3 illustrates a froth separator that may be used to use froth flotation to separate the solid reaction product from an aqueous mixture according to certain embodiments.

FIG. 4 illustrates a precipitation reactor and system that may be used according to certain embodiments.

FIG. 5 is a schematic illustration of a solid electrolyte interphase layer covering a graphite anode in a lithium-ion battery.

FIG. 6 is a block diagram illustrating a system for generating and purifying solid carbon according to certain embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

### INTRODUCTION

In certain implementations, the embodiments disclosed herein provide improved methods of generating and purifying solid carbon. In various embodiments, the solid carbon is electrolytically generated at a cathode of an electrolysis reactor. Molten carbonate salt electrolyte (e.g., lithium carbonate) is provided in the electrolysis reactor, and solid carbon is produced as carbonate ions are reduced at the cathode. The carbonate ions are primarily generated from the molten carbonate salt electrolyte. The electrolysis reactor may be referred to as a carbon dioxide reduction electrolyzer, although the disclosed embodiments focus reducing lithium carbonate, which in a sense comprises carbon dioxide. It will be understood that electrolysis reactor and carbon dioxide reduction electrolyzer are used interchangeably herein.

The electrolysis reactor produces a reaction product that includes solid carbon, lithium oxide (Li₂O), and unreacted lithium carbonate (Li₂CO₃). The unreacted lithium carbonate is from the carbonate salt electrolyte. After the reaction product is removed from the electrolysis reactor, it is cooled to form a solid reaction product. The solid reaction product may also include other materials, including but not limited to other carbonate salts present in the electrolysis reactor. The other carbonate salts (e.g., sodium carbonate, potassium carbonate, etc.) may be provided to adjust the melting temperature of the electrolyte, or for another purpose.

Because the solid reaction product includes on the order of about 10 wt % solid carbon, the carbon needs to be purified before it can be used for most applications. The purification involves separating the solid carbon from the lithium oxide and the lithium carbonate. Onc advantage of the purification process is that it regenerates lithium carbonate, which can be recycled to the electrolysis reactor. Because lithium carbonate is a relatively expensive material, such recycling can substantially reduce the cost of producing the solid carbon. Another advantage of the purification process is that it uses carbon dioxide (CO₂) as a feedstock.

Carbon dioxide is a widely available raw material and its release into the atmosphere is responsible for environmental degradation. The extensive burning of fossil fuels for generating electricity and other industrial processes results in the release of large amounts of greenhouse gases such as carbon dioxide, thereby increasing the concentration of CO₂ in the atmosphere. There is a growing consensus among the scientific community that the increasing concentration of CO₂ in the atmosphere is contributing to global warming. The consequences of global warming include melting of polar ice caps, rising sea levels, endangering coastal communities, threatening arctic and other ecosystems, and increasingly frequent extreme weather events such as heat spells, droughts, and hurricanes. Thus, there exists a need for methods which provide for the sequestration and utilization of CO₂ generated from the burning of fossil fuels and other industrial applications.

Some methods of electrolytic carbon generation use CO₂ as a feedstock in the electrolytic reactor. However, it has been found that CO₂ parasitically reacts with solid carbon, thus reducing the electrolysis yield. In the methods described herein, CO₂ can be used as a feedstock to purify the solid carbon after it is generated in the electrolysis reactor. Some of the CO₂ is consumed as the solid carbon is purified and Li₂CO₃ is regenerated. The regenerated Li₂CO₃ can then be recycled to the electrolysis reactor, where it reacts to form additional solid carbon. This technique provides a much more efficient way to consume CO₂ in the generation and purification of solid carbon, as compared to providing the CO₂ directly to the electrolysis reactor.

As used herein, the term “solid carbon” includes graphite, carbon black, amorphous carbon, carbon nanotubes, graphene, activated carbon, fullerenes, and similar solid elemental carbon materials that are formed in the electrolysis reactor. The term solid carbon does not include the carbon that is found in compounds such as lithium carbonate or lithium bicarbonate (LiHCO₃). Solid carbon includes only carbon atoms, except to the extent that any impurities are present.

The solid carbon formed at the cathode may coat and adhere to the cathode. Therefore, the electrolysis reactor may employ a mechanism to dislodge or otherwise separate the graphite from the cathode. In some cases, this mechanism vibrates or otherwise agitates the positive electrode with sufficient energy to shear the graphite from the electrode. In one example, the mechanism vibrates the cathode at or near its resonance frequency. In other implementations, the mechanism vibrates the electrolyte through sonication. Operated in these manners, deposited graphite dislodges from the electrode and forms a suspension in the electrolyte. In another approach, the cathode is scraped continuously or periodically to remove deposited graphite. In some cases, the cathode rotates or otherwise moves with respect to a fixed position scraper. In other embodiments, a scraper moves with respect to a fixed position cathode. Regardless of how the solid carbon is dislodged from the cathode, the carbon needs to be separated from the other components in the reaction product. The techniques described herein utilize carbon dioxide and a hydrogen-donor solvent to purify the solid carbon and regenerate the lithium carbonate electrolyte.

### Process

Various disclosed embodiments involve a solid carbon material production process. One example of solid carbon material is graphitic carbon. During a solid carbon material production process, the deposit material coming from the electrolysis reactor may be a solid mixture of graphitic carbon, lithium oxide, and lithium carbonate. One example composition of the solid mixture may have about 10 wt. % graphitic carbon, about 25 wt. % lithium oxide, and/or about 65 wt. % lithium carbonate. In some embodiments, the solid carbon material production process involves using spent lithium-ion battery material.

Provided herein are methods of filtering and purifying carbon using froth flotation to reduce and simplify the overall system.

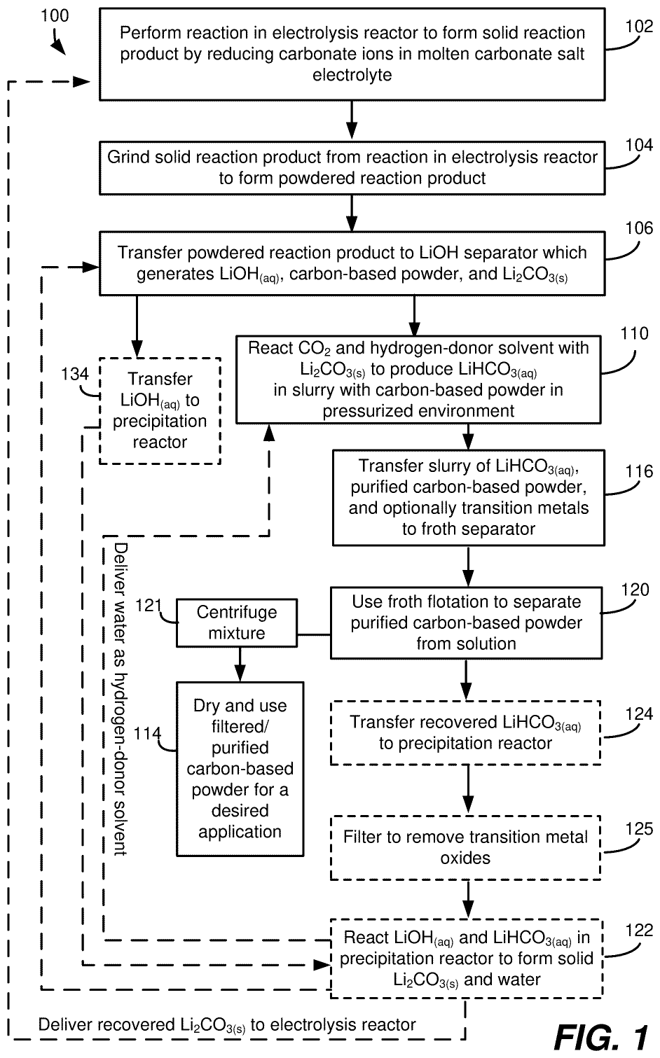

FIG. 1 shows an example process flow diagram for utilizing froth flotation in certain disclosed embodiments. The method 100 begins at operation 102, where a reaction is performed in an electrolysis reactor to form a solid reaction product by reducing carbonate ions in molten carbonate salt electrolyte. The reactions that occur in the electrolysis reactor are described in Reactions 1-6 further below.

The reaction product that leaves the electrolysis reactor is partly molten, but rapidly solidifies as it cools. At operation 104, the solid reaction product is ground into a powdered form. The powdered form of the reaction product may be referred to as the powdered reaction product. The powdered reaction product may include a solid carbon material such as carbon-based powder.

At operation 106, the powdered reaction product is transferred to a LiOH separator, which generates LiOH_{(aq)}, carbon-based powder, and Li₂CO₃₍ₛ₎ by reacting the powdered reaction product with a hydrogen-donor solvent such as water (H₂O). Reaction 7 described further below may be performed in operation 106. The mixture reacts in the LiOH separator until the powdered reaction product ceases to react, thereby forming mixture of carbon-based powder and solid lithium carbonate, and dissolved LiOH. The LiOH separator may generate LiOH_{(aq)} that may be provided (such as via a pump or other recycling mechanism) to a precipitation reactor as shown in operation 122. In various embodiments, water from operation 122 may be optionally recycled to the LiOH separator to be used in operation 106.

At operation 110, the mixture having solid carbon and solid lithium carbonate are delivered to a pressurized carbonation reactor in a pressurized environment. The carbonation reactor converts the solid lithium carbonate to dissolved lithium bicarbonate in a pressurized environment. Carbon dioxide may be used as a feedstock to deliver carbon dioxide to the pressurized carbonation reactor. A hydrogen-donor solvent such as H₂O may also be delivered to the pressurized carbonation reactor. The reaction of solid lithium carbonate with carbon dioxide and H₂O is carried out at slight overpressure (up to about 30 psi CO₂ pressure). The advantages are that (1) more lithium carbonate can be digested per volume of H₂O to produce a more concentrated lithium bicarbonate solution and (2) the conversion rate of lithium carbonate to lithium bicarbonate is greatly enhanced. Pilot-scale testing has shown that at 30 psi CO₂ pressure the resulting lithium bicarbonate solution is about 30% more concentrated than at ambient CO₂ pressure, while reducing the conversion time from about 24 hours to about 4 hours. The reaction product is a slurry having aqueous lithium bicarbonate, and carbon-based powder.

At operation 116, the slurry including carbon-based powder, lithium bicarbonate, and, in some cases, trace impurities (such as transition metals which may be drawn from the chambers/tools, spent battery materials, or the environment) are delivered to a froth separator.

In operation 120, the carbon-based powder is separated from the aqueous solution by froth flotation. In operation 121, the mixture is centrifuged. The graphite concentrate from the froth flotation machine is gravity-fed into the centrifuge where it can be centrifuged between about 1600 rpm to about 1800 rpm for about 15 minutes to separate the liquid lithium bicarbonate from the graphite. In some embodiments, residual moisture levels after centrifugation are between about 30 wt. % to about 45 wt. %. After most of the lithium bicarbonate has been reclaimed, tap water is introduced into the centrifuge (approximately 10 liters of water per kg of graphite) by using a spray bar while the centrifuge is still spinning at about 1600 rpm to about 1800 rpm. The introduced water will replace the trapped liquid (lithium bicarbonate) held in the pores of the graphite filter cake by capillary forces and allow for additional reclamation of lithium bicarbonate.

In operation 114, the froth filter cake is extracted from the centrifuge and dried to form carbon-based powder for a desired application. An example application is formation of battery-grade graphite. The remaining aqueous solution may be filtered and/or recycled; for example, the transition metals (such as iron) may be filtered in an operation 125 after transferring recovered LiHOC₃ to a precipitation reactor in operation 124, and the lithium bicarbonate may be recovered and provided to a precipitation reactor in operation 122. In some cases, the hydrogen-donor solvent may also be optionally recycled to the LiOH separator and/or the carbonation reactor. In operation 122, the precipitation reactor may receive feedstock CO₂ to react lithium hydroxide and lithium bicarbonate to form solid lithium carbonate and water. Subsequently, recovered Li₂CO₃ can be optionally provided to the electrolysis reactor, and hydrogen donor-solvent can be optionally provided to the LiOH separator and carbonation reactor (operation 110).

### Cathode Reaction in Electrolysis Reactor

The below description describes example reactions that may occur in the electrolysis reactor in accordance with certain disclosed embodiments. At the cathode, one or more carbon-containing reactants are reduced to form a solid carbon material. In many cases, the following reactions occur at the cathode:

Li₂CO₃₍ₗ₎→2Li⁺+CO₃²⁻ Reaction 1

CO₃²⁻+4e⁻→C₍ₛ₎+3O²⁻ Reaction 2

2Li⁺+O²⁻→Li₂O₍ₛ₎ Reaction 3

At temperatures above 723° C., the lithium carbonate electrolyte melts and dissociates into lithium ions (Li⁺) and carbonate ions (CO₃²⁻), as shown in Reaction 1. The reduction of the carbonate ion consumes four electrons and produces one carbon and three oxygen anions (O²⁻), as shown in Reaction 2. One oxide anion reacts with two lithium ions to produce lithium oxide, as shown in Reaction 3.

The carbonate ion may originate from the electrolyte directly (e.g., as part of the bulk electrolyte provided before or during electrolysis). In some cases, additional carbonate ions may be formed through the reaction of dissolved carbon dioxide with oxide ion in the molten electrolyte. However, as mentioned above, carbon dioxide may parasitically react with solid carbon. As such, in many cases carbon dioxide is not fed to the electrolysis reactor, and most or all of the carbonate ions originate from the carbonate salt electrolyte (e.g., from the lithium carbonate, optionally from other carbonate salts as desired for a particular application).

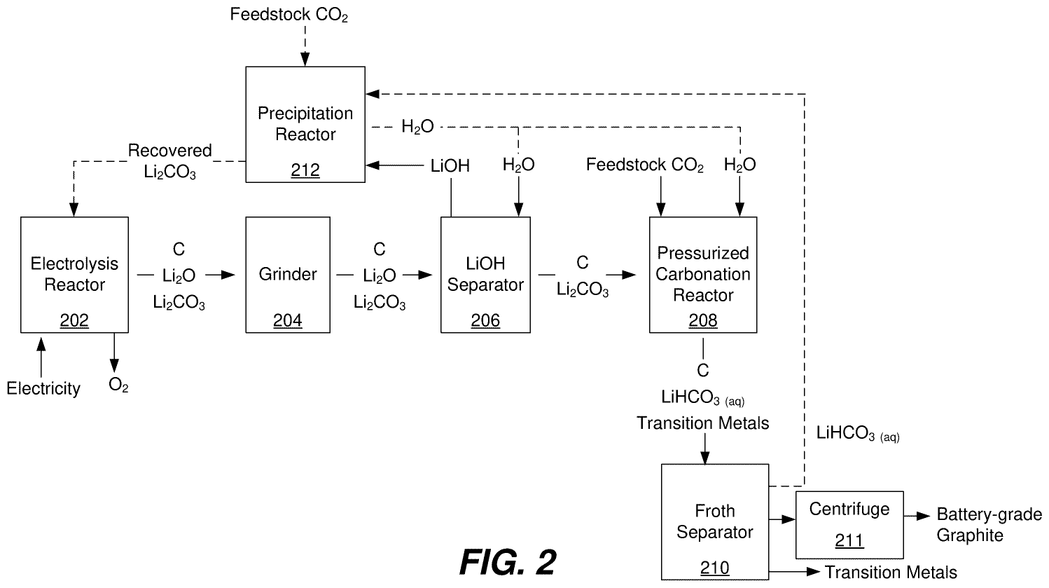

These reactions may take place in electrolysis reactor 202 as described below with respect to FIG. 2.

### Anode Reaction in the Electrolysis Reactor

In various embodiments, elemental oxygen (O₂) evolves at the anode. As mentioned, oxide anion is produced at the cathode through reduction of the carbonate anion (and in some cases reduction of carbon dioxide, if fed to the electrolysis reactor). The anode reaction may be represented as follows:

2O²⁻→O_{2(g)}+4e⁻ Reaction 4

In cases where carbon dioxide is fed to the electrolysis reactor, another reaction which may occur at the anode is the formation of carbonate ion from carbon dioxide and oxide anion according to Reaction 5.

CO_{2(g)}+O²⁻→CO₃²⁻ Reaction 5

This reaction may help replenish carbonate ion in the electrolyte in certain embodiments where carbon dioxide is fed to the electrolysis reactor. As mentioned above, the carbon dioxide is omitted from the electrolysis reactor in many cases. These reactions may take place in electrolysis reactor 202 as described below with respect to FIG. 2.

### System

FIG. 2 shows an example system for producing graphitic carbon. Lithium carbonate and water can be recycled with minimal losses.

In the electrolysis reactor 202, the inputs are carbon dioxide (CO₂) and electricity and the main outputs are a carbon material (such as graphitic carbon) and oxygen gas (O₂) (see Reaction 6). The reaction product generated from the electrolysis reactor includes lithium carbonate, lithium oxide, and carbon material.

Li₂CO₃₍ₛ₎→Li₂O+C+O₂ Reaction 6

The reactions in the electrolysis reactor may be controlled to produce solid carbon material having a desired set of properties. For some applications, a highly or moderately crystalline graphite is desirable. Graphite crystallinity is typically measured in terms of the crystallite height, which is effectively a measure of the number of graphene sheets stacked on one another in a crystallite. In other words, it is a measure of the z-direction height of a crystallite-assuming that the x and y directions are in the plane of a graphene sheet. Naturally occurring graphite has a crystallite height of approximately 200 to 300 nanometers. Commonly produced synthetic graphite has a crystallite height of approximately 10 to 180 nanometers. The crystallite height produced using methods described herein may have a height of about 50 to 500 nanometers, depending on the desired use of the graphite. In various embodiments, the weight fraction of crystalline graphitic carbon is greater than about 95%. In some cases, a highly crystalline form of graphite-one resembling naturally occurring graphite—is produced. In such cases, the crystalline height may be about 150 to 300 nanometers.

To control crystallinity, one may design the electrolysis reactor to control the electrochemical deposition conditions at the cathode, the rate or frequency at which graphite is removed from the cathode, and/or the surface conditions of the cathode and/or anode. Methods for controlling the deposition conditions are further described in U.S. Pat. No. 9,290,853, titled “ELECTROLYTIC GENERATION OF GRAPHITE,” which is herein incorporated by reference in its entirety.

In certain embodiments, the surface of the cathode is designed to provide a morphological “template” promoting a desired level of crystallinity. In some embodiments, the cathode surface contains a carbide to act as a template. Example carbides include, but are not limited to, titanium carbide, iron carbide, chromium carbide, manganese carbide, silicon carbide, nickel carbide, and molybdenum carbide. The species of carbide chosen for a certain application may depend on various factors including the desired qualities of the graphite and the properties of the cathode itself. In some embodiments, the cathode surface contains graphite. The carbide, graphite, or other “template” surface may be provided as a thin continuous layer, a discontinuous layer, or as a monolithic structure that sometimes comprises the entire electrode. In certain embodiments where a thin layer is used, the layer has a thickness of about 1 to 500 nanometers. The thin layer is provided on an appropriately electrically conductive substrate such as stainless steel or titanium.

In certain embodiments, the cathode and/or anode are porous. In such embodiments, the electrode may have a porosity of between about 0 and 0.7 for example. Porous electrodes have a relatively high surface area per unit volume, thereby promoting relatively high mass deposition rates within the electrochemical cell (as compared to non-porous electrodes). In certain embodiments, the electrode surface is made relatively rough. A rough electrode surface provides nucleation sites (protrusions) to facilitate initiation of the graphite deposition reaction and facilitate uniform deposition over the electrode surface. In some implementations, the surface roughness (Ra) is between about 10 and 1000 micrometers. Generally speaking, many different types of electrodes may be used, as described further below.

The carbon or graphite particles or flakes present in the electrolyte (and separated therefrom) typically have a principal dimension (longest linear dimension) of about 0.1 to 1000 micrometers. The principal dimension is the particle diameter, assuming generally spherical particles.

While certain embodiments described herein have focused on deposition of graphitic carbon, other solid carbon reaction products besides graphite may be produced in various embodiments. For example, other forms of elemental carbon such as carbon black, graphene, amorphous carbon, activated carbon, carbon nanotubes, and fullerenes may be produced.

The electrolyte is typically a molten salt such as an alkali metal carbonate. Lithium carbonate is one example. Other examples include sodium carbonate and potassium carbonate. Some electrolytes are made from mixtures of two or more of these carbonates. In some cases, the electrolyte contains between about 30 and 75% by mass lithium carbonate. In one example, the electrolyte contains about 40 to 60% by mass lithium carbonate. Other electrolyte components may include conductivity enhancing additives such as metal chlorides. Example metal chlorides include, but are not limited to, lithium chloride, sodium chloride and potassium chloride. The metal chlorides may also be helpful in controlling the melting point of the electrolyte. In alternative embodiments, the electrolyte is an ionic liquid. Example ionic liquids include, but are not limited to, 1-Ethyl-3-methylimidazolium tetrafluoroborate (EMIM-BF₄) and counter-anion derivatives thereof, PF₆, halides, pseudohalides, and alkyl substituted imidazolium salts. Although certain ionic liquids may be functionally appropriate for use as the electrolyte, their use may be limited by other considerations such as cost.

The electrolyte should remain in a molten liquid state. Because typical electrolyte materials (e.g., alkali metal carbonates) are solid at room temperature, a relatively high temperature should be employed, although typically below about 900° C. In certain embodiments, an electrolyte temperature of about 450° C. to 900° C. is maintained. In other embodiments, an electrolyte temperature of about 500° C. to 750° C. is maintained. The temperature should not be so high that it aggressively degrades the components of the reactor, including the electrodes.

In certain embodiments where a carbonate-based electrolyte is used, the electrolyte has a viscosity between about 20 and 300 centipoises without taking into account the presence of carbon particles in the electrolyte. In certain embodiments, the electrolyte viscosity is between about 20-100 centipoise. The viscosity of the molten carbonate/solid carbon slurry may be between about 30-1000 centipoise in certain embodiments. The viscosity of the molten carbonate/solid carbon slurry will depend on, among other factors, the amount of solid carbon present in the slurry.

In many embodiments, the flow of electrolyte at the surface of the electrode is laminar during deposition. In other implementations, the flow of electrolyte is laminar during a substantial portion of the deposition process, and a turbulent electrolyte flow is used periodically to facilitate removal of the electrodeposited carbon. For instance, the flow rate of electrolyte may be periodically increased to produce a turbulent flow in which the shear stress of the fluid passing over the electrodeposited carbon has sufficient force to dislodge the carbon from the surface of the electrode. Turbulent flow may be introduced after a period of time has passed or at a particular frequency, or after the deposited carbon reaches a certain thickness.

Under typical conditions, carbon begins depositing within the first few minutes of the reaction, and the crystalline quality of the carbon (e.g., graphite in many cases) improves as more carbon is deposited. As such, in certain implementations it is beneficial to allow the deposition to continue for relatively long periods of time (e.g., more than 30 minutes, more than 1 hour, more than 2 hours, or even longer in certain implementations) before the material is actively removed from the cathode surface.

Returning to FIG. 2, the electrolysis reaction product from electrolysis reactor 202 is delivered to a grinder 204, and the ground product is delivered to a LiOH separator 206. Water (H₂O) is provided to the LiOH separator 206 to cause Reaction 7 as noted below. Lithium carbonate remains primarily unreacted and in a solid state for transport along with the solid carbon.

Processing in the LiOH separator and in the carbonation reactor can (1) isolate and purify the solid carbon material and (2) recover the lithium compounds as lithium carbonate for reuse in the electrolysis process. To achieve this, all solid lithium compounds may be converted into their H₂O-dissolved state according to the Reactions 7 and 8 below.

Li₂O₍ₛ₎+H₂O→2LiOH_{(aq)} Reaction 7

Li₂CO₃₍ₛ₎+H₂O+CO₂⇄2LiHCO_{3(aq)} Reaction 8

The mixture or slurry generated from the LiOH separator 206 is provided to pressurized carbonation reactor 208, whereby Reaction 8 may take place. In various embodiments, the molar ratio of LiHCO₃ to LiOH may be about 1:1. The reaction products from the pressurized carbonation reactor 208 include solid carbon, aqueous lithium bicarbonate, and trace impurities such as transition metals. Lithium carbonate is converted to a significantly more soluble species, lithium bicarbonate, when reacted with carbon dioxide (CO₂) as shown in Reaction 8. In pressurized carbonation reactor 208, the process utilizes CO₂ as a feedstock. A hydrogen-donor solvent such as H₂O may be provided either from another source or from a precipitation reactor 212 further described below.

It may be challenging to separate or purify the carbon material generated from a system such as described above. Provided herein are methods, apparatuses, and systems for using froth flotation to filter carbon materials while still recycling byproducts from the system which can reduce waste and enable a more efficient process. Additional embodiments also involve using a precipitation reactor to further recycle lithium carbonate. Additional embodiments also involve using certain disclosed embodiments to recycle graphite anode material for lithium-ion batteries. In various embodiments, heat is not used in certain operations. In some embodiments, electrical energy is used to power stirring, agitating, and pumping of liquids.

The slurry or mixture from pressurized carbonation reactor 208 may be provided to a froth separator 210 which is used to filter and purify solid carbon material. The mixture can then be centrifuged at a centrifuge 211. Lithium bicarbonate can be provided to a precipitation reactor 212, which can be used to recover lithium carbonate, which can further be used in the electrolysis reactor 202.

Dotted lines in FIG. 2 show optional transfers of material that may or may not take place. Solid lines show transfers of material and/or recycling of material or input from feedstock that may take place. Recycling as described herein may be implemented by using any type of recycling technique or recycler, including manual recycling (such as collecting and manually inputting into another reactor), automated recycling (such as via filter, pump, or other mechanical techniques), or other methods of recycling.

In various embodiments, operations in each reactor may be performed for a certain duration. For example, in some embodiments, LiOH separation in LiOH separator 205 is performed for about 4 hours to about 8 hours or about 6 hours. In some embodiments, carbonation in pressurized carbonation reactor 208 may be performed for about 4 to 24 hours In some embodiments, precipitation in precipitation reactor 212 may be performed for about 1 hour to about 3 hours or about 2 hours.

Components of FIG. 2 are now further described in the sections below.

### Froth Separator

Carbonation produces a slurry composed of liquid lithium bicarbonate (LiHCO₃; pH ˜7.6), solid carbon material (such as graphitic carbon), and transition metals (mostly nickel, iron, chromium in their oxide form from crucible and electrode corrosion). This represents the feed stream that is sent to the froth separator in order to separate the solid carbon material from the liquid aqueous mixture having lithium compounds (such as lithium bicarbonate), while also removing the aforementioned transition metals. Due to its high crystallinity and hydrophobic nature, the solid carbon material generated from certain disclosed embodiments responds very well to separation by froth flotation. When sufficiently agitated and sparged with air, the hydrophobic solid carbon material attaches to air bubbles in suspension and move to a froth layer on the top of fluid and are thus separated from hydrophilic and high-density particles (transition metal oxides) which remain in the suspension or the bottom of the tank. Froth flotation therefore achieves both separation and purification of the solid carbon material.

Certain disclosed embodiments have the additional advantage that the mixture of lithium compounds (such as lithium bicarbonate) and solid carbon material is frothable (e.g., capable of generating a froth therefrom) without the use of any additives (e.g., pine oil etc.). Up to at least about 95% of the solid carbon material can be separated and purified in a single-pass froth flotation operation. Without being bound by a particular theory, it is believed that the frothability of the mixture is due to excess CO₂ in the mixture, which renders the liquid slightly “fizzy.” Subsequently, the carbon-depleted aqueous solution of lithium bicarbonate is filtered and transferred to the precipitation reactor where it is combined with lithium hydroxide to precipitate out the lithium carbonate. Solid carbon material such as graphite is a particularly appropriate material for froth separation from a two-phase aqueous mixture because it is hydrophobic and preferentially attaches to froth.

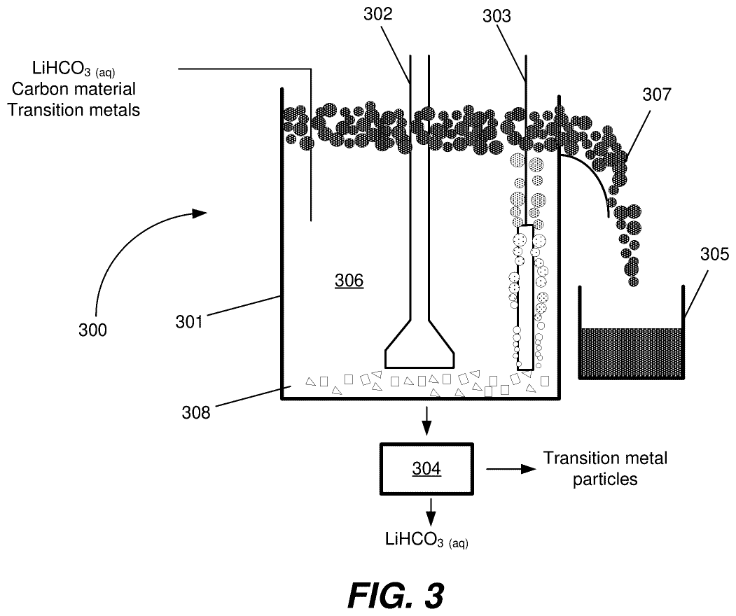

Features of the froth separator is further described below. FIG. 3 depicts an example froth separator. The froth separator includes a vessel 300 having vessel walls 301, an agitator (or propeller) 302, a gas sparger 303, a filter 304, and optionally a collector 305 which collects concentrate, which in some embodiments may be a solid carbon material collector. The vessel 300 is configured to hold an aqueous mixture 306 having lithium compounds, such as lithium bicarbonate in aqueous form, as well as solid carbon material and transition metals.

During use of the froth separator, the agitator 302 and/or gas sparger 303 agitates the aqueous solution and introduces air, thereby generating froth 307 that includes solid carbon material (which may be, in some embodiments, graphite). The agitator 302 may be agitated at a spin speed of about 300 rpm to about 700 rpm or about 500 rpm. The speed may depend on the size of the stir blades of the agitator 302. In some embodiments, larger stir blades may reduce the speed at which the blades are spun. The froth 307 rises to the surface of the liquid in a froth, while higher density, non-hydrophobic impurities such as transition metal particles settle at the bottom of the vessel. The agitator 302 may split up the air bubbles coming from the sparger 303 and increase bubble surface area. Graphite attaches itself to the air bubbles as they are rising through the graphite-laden suspension to form a froth 307 at the surface of the suspension. Shaded bubbles in FIG. 3 depict graphite loading of the bubbles.

The froth 307 having the solid carbon material can be collected in or delivered to a solid carbon material collector 305 manually (such as by scooping, scraping, or using a sieve) or by an automated and rotating froth skimmer. After the solid carbon material froth is removed from the mixture of an aqueous solution, the remaining mixture of an aqueous solution is filtered to sift out transition metal particles 308 and yield an aqueous solution having lithium bicarbonate which may in some embodiments be a substantially pure solution of lithium bicarbonate. The aqueous solution having lithium bicarbonate can be recycled to be used in other parts of the system.

### Precipitation Reactor

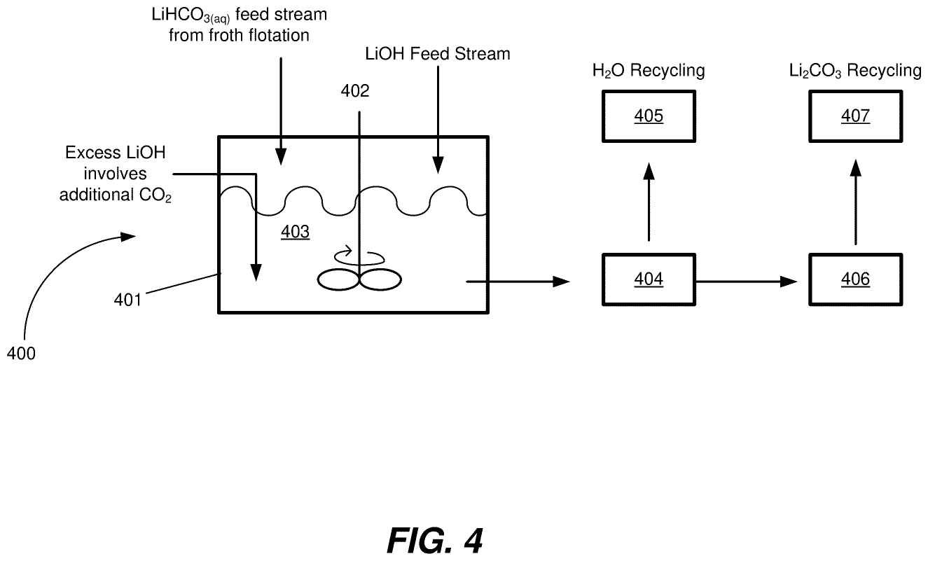

In various embodiments, solid lithium carbonate is recovered via a substantially heatless precipitation method using a precipitation reactor and system such as described with respect to FIG. 4. By controlling the reaction conditions, a substantial fraction of the lithium compounds in solution may be precipitated as lithium carbonate. This may avoid the need for using large amounts of energy to precipitate by H₂O evaporation.

In the overall system, the precipitation reactor may be such as described above with respect to precipitation reactor 212 in FIG. 2. FIG. 4 shows a detailed example of a precipitation reactor and subsequent processing. The precipitation reactor includes a vessel 400 having vessel walls 401, and an agitator 402. A LiHCO₃ feed stream from, e.g., froth flotation and a LiOH feed stream from, e.g., a LiOH separator may be delivered to the vessel 400 as aqueous solutions 403. In some cases, the feedstock of carbon dioxide may be supplemented with carbon dioxide recycled from another component of the system (e.g., from the evaporation reactor). In some embodiments, the precipitation reactor may have excess LiOH. The precipitation reactor may be operated to consume carbon dioxide, as necessary to facilitate reaction of LiHCO₃ and LiOH to produce insoluble Li₂CO₃. The amount of carbon dioxide added may be very little, such as about 0.62 g of carbon dioxide per kg of solution 403. The added carbon dioxide may help control the pH and/or molar ratio of LiHCO₃ and LiOH. The lithium bicarbonate reacts with the lithium hydroxide to form a suspension of solid lithium carbonate in water. The agitator 402 stirs the aqueous mixture which separates solid material via the reaction below:

LiHCO_{3(aq)}+LiOH⇄Li₂CO₃₍ₛ₎↓+H₂O Reaction 9

This suspension can be passed to a filter module 404 which may be a filter press or belt filtration module to separate the components into recovered lithium carbonate and recovered solvent (e.g., recovered water in many cases). The filtration module may be integral with the packed column, or it may be separate. After filtering, water may be vented or be delivered to a water recycler 405 to recycle water back into the system. After the water is filtered from the mixture, the mixture is transferred to a dryer 406 where a solid lithium carbonate is generated. In various embodiments, as soon as LiOH and LiHCO₃ have been introduced into the precipitation reactor and the pH adjusted to 11.8 with CO₂, the precipitation reaction takes place which may take about 2 hours. The mixture may be stirred during this time.

The recovered lithium carbonate can be sold (not shown), or it can be recycled to a lithium carbonate recycler 407 which can deliver the Li₂CO₃ to the electrolysis reactor for producing additional solid carbon material. This provides an efficient and useful mechanism for converting carbon dioxide into solid carbon. The precipitation reactor may have a variety of sensors including a pH sensor, temperature sensor and a pressure sensor.

The aqueous lithium carbonate recovery process produces two liquid feed streams, namely concentrated LiOH_{(aq)} from the LiOH separation and close-to-saturated LiHCO_{3(aq)} from the carbonation reactor/froth flotation. Both liquids are subsequently combined in the precipitation reactor, where they precipitate as lithium carbonate according to Reaction 9.

Equimolar amounts of both liquids will precipitate the maximal amount of lithium carbonate and leave behind a lithium-depleted supernatant solution ready to be introduced into the process again (such as via H₂O recycling). Precipitation starts instantaneously and is usually completed within 2 hours.

The precipitation reaction is conducted under conditions in which lithium carbonate is minimally soluble in an aqueous solution. The equivalence point in this acid-basic titration system is at pH 11.8 and ensures maximal precipitation.

### Lithium Ion Battery Application

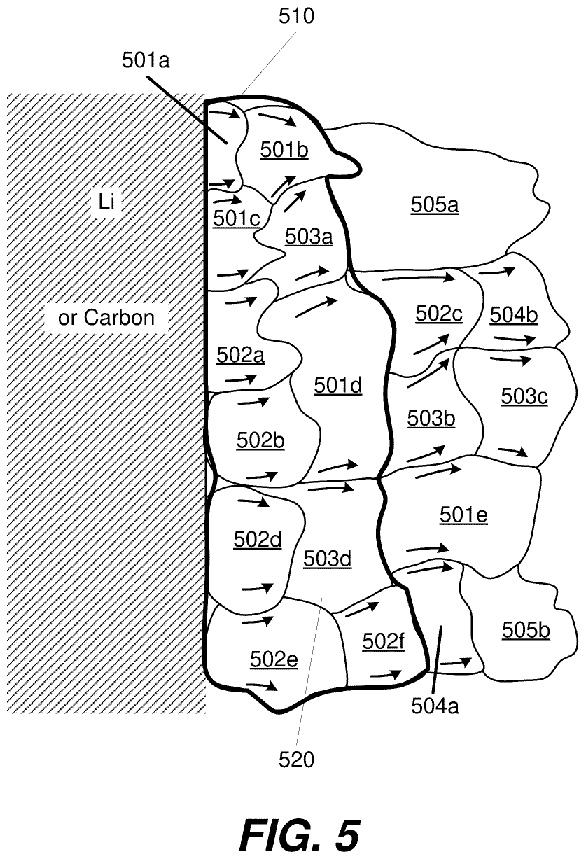

Certain disclosed embodiments may be used in the context of lithium-ion battery material recycling. Recycling carbon material such as graphite from spent lithium-ion battery anodes plays a significant role in relieving the shortage of graphite resources and environmental protection. In spent batteries, the graphite anode may be covered with a solid electrolyte interphase (SEI) layer such as shown in FIG. 5. The SEI will inevitably evolve during repeated charging/discharging cycles. The two main inorganic phases within the SEI are lithium carbonate (503a, 503b, 503c, and 503d) and lithium oxide (502a, 502b, 502c, 502d, and 502c), which makes it very similar to the composition of the deposit in the graphitic carbon production described above with respect to FIGS. 1-4. The SEI may include lithium fluoride (501a, 502b, 501c, 501d, and 501c). The bolded line 510 shows the mixture of the SEI layer. In some embodiments, the surface of the lithium or carbon may also include semi-carbonate 504a and 504b and polyolefin 505a and 505b.

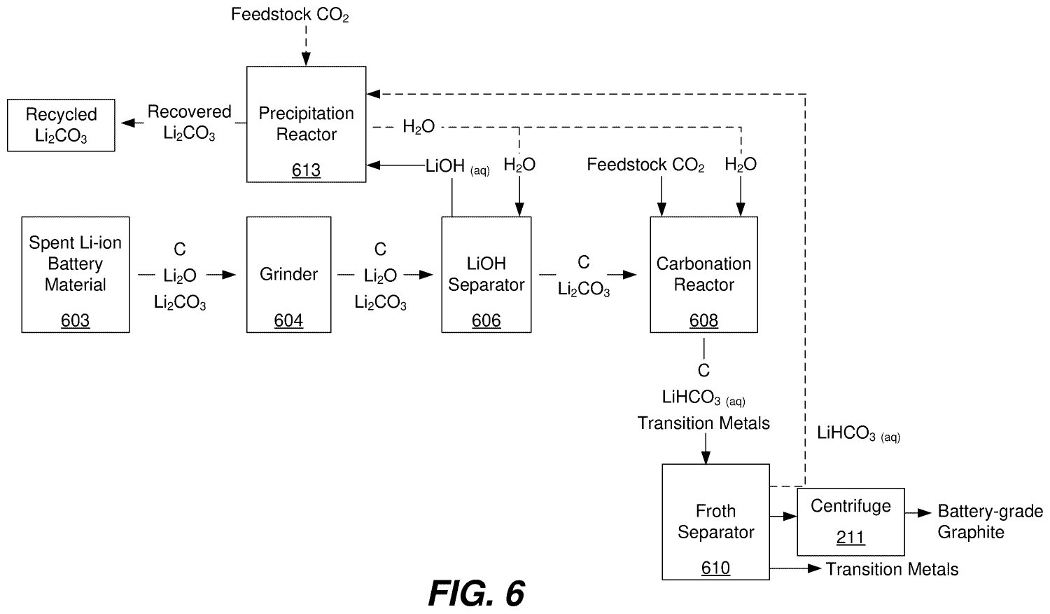

FIG. 6 shows an example system that incorporates spent lithium-ion battery material into certain disclosed embodiments to generate carbon material and recycle lithium carbonate as well as other byproducts from the process. FIG. 6 begins at 603 where, after organic components are removed, spent lithium ion battery material is processed to form solid carbon material, Li₂O, and Li₂CO₃. The mixture is processed in grinder 604 to a powdered form to form a powdered mixture having solid carbon material, Li₂O, and Li₂CO₃.

The grinder receives the reaction product after it is cooled to form the solid reaction product. The solid reaction product is relatively course when it enters the grinder. The grinder includes mechanical components configured to grind the solid reaction product into a powder. Such components may include, e.g., a flywheel having an eccentric shaft and bearing, as well as a fixed jaw and a moving jaw. The flywheel operates to move the moving jaw, which grinds the solid reaction product against the fixed jaw as the reaction product passes through the jaws. The purpose of grinding the solid reaction product is to substantially increase the ratio of surface area to volume for the solid reaction product, which makes it easier for the carbon dioxide and hydrogen-donor solvent to penetrate into the solid reaction product in the extraction vessel, where it reacts with the lithium-containing compounds (e.g., lithium oxide, lithium hydroxide, and lithium carbonate) to form aqueous lithium bicarbonate. With reference to the system of FIG. 2, the grinding also makes it easier for water to penetrate into the solid reaction product to react with lithium oxide to form lithium hydroxide in the washer, in cases where the solid reaction product is washed before providing it to the extraction vessel.

Generally speaking, the finer the solid reaction product is ground, the easier it is to extract the lithium compounds and purify the solid carbon. In some cases, the solid reaction product is ground until the average diameter of the particles is between about 0.05-25 mm.

The grinder may be powered by the same or different source that powers the electrolysis reactor.

The powdered mixture is delivered to an LiOH separator where a reaction takes place to generate aqueous LiOH, solid carbon material, and Li₂CO₃. The aqueous LiOH may be recycled to a precipitation reactor 613. Water may be delivered to the LiOH separator 606. The aqueous mixture is then processed at a pressurized carbonation reactor 608 where it undergoes a reaction using feedstock CO₂ and either recycled or additional H₂O (or other hydrogen-donor solvent) to form an aqueous mixture of solid carbon material, LiHCO₃, and transition metals. The aqueous mixture undergoes froth flotation at a froth separator 610 where the froth can be centrifuged in centrifuge 611 to separate and collect battery-grade carbon material such as graphite. The transition metals can be filtered and the aqueous LiHCO₃ may be recycled to a precipitation reactor 613 which can undergo reactions with feedstock CO₂ to recover Li₂CO₃, which can be further recycled or used in other processes.

### Power Source

The power source employed to drive the electrochemical reactions and related purification and separation processes in certain disclosed embodiments will be designed or chosen to meet the requirements of the reactor size. For industrial processes, the electrolysis reactor may require currents of ˜50 kA. In some embodiments, the total system may require currents on the order of about 50 kA. With respect to the electrolysis reactor, in certain embodiments, there will be a control mechanism in place that uses active feedback of temperature through the use of a thermocouple or other temperature sensor. The control mechanism may control the cell voltage (potentiostatic or potentiodynamic control). In other implementations, the control mechanism may control the cell current (amperostatic or amperodynamic control). In some implementations, the controller will employ a control algorithm for delivering voltage or current to the electrodes of the cell. Such algorithm may employ pulsing, ramping, and/or holding the cell potential and/or current at particular stages of the electrochemical process.

The power supply and control system, which may control one or more aspects of the electrolysis reactor and/or the system in which the electrolysis reactor is implemented, are discussed further below.

### Controller

In various embodiments, a controller is part of a system, and may be implemented in any of the examples described herein. Such systems can include any of the components described herein, for example those shown in FIGS. 2, 4, and 6. These components may be integrated with electronics for controlling their operation before, during, and after processing. The electronics may be referred to as the “controller,” and they may include a number of different components or subparts of the system or systems. The controller may be programmed to control any and all of the processes described herein.

In some embodiments, the power supply and control system (collectively a controller) includes a processor, chip, card, or board, or a combination of these, which includes logic for performing one or more control functions related to the electrolysis reactor and/or any other component of the system. Some functions of the controller may be combined in a single chip, for example, a programmable logic device (PLD) chip or field programmable gate array (FPGA), or similar logic. Such integrated circuits can combine logic, control, monitoring, and/or charging functions in a single programmable chip.

In general, the logic used to control the electrical potential and current provided to the electrodes and/or the mechanisms for circulating electrolyte and/or the mechanisms for dislodging graphite from the cathode can be designed or configured in hardware and/or software. Similarly, the logic can control any aspect of the method described in FIG. 1 and/or the systems described in FIGS. 2, 4, and 6. Such aspects can include, but are not limited to, transfer of materials from one system component to another, operation of the grinder (e.g., power, mechanical settings controlling the resulting powdered reaction product, etc.), operation of the washer (e.g., temperature, pressure, circulation of fluids, timing, etc.), operation of a precipitation reactor for regenerating lithium carbonate from lithium hydroxide and carbon dioxide (e.g., temperature, pressure, circulation of fluids, timing, etc.), operation of the extraction vessel (e.g., temperature, pressure, circulation of fluids, timing, etc.), operation of the evaporation reactor (e.g., temperature, pressure, circulation of fluids, timing, etc.), etc. The instructions for controlling these aspects may be hard coded or provided as software. It may be said that the instructions are provided by “programming.” Such programming is understood to include logic of any form including hard coded logic in digital signal processors and other devices which have specific algorithms implemented as hardware. Programming is also understood to include software or firmware instructions that may be executed on a general purpose processor. In some embodiments, instructions for controlling application of voltage to the batteries and loads are stored on a memory device associated with the controller or are provided over a network. Examples of suitable memory devices include semiconductor memory, magnetic memory, optical memory, and the like. The computer program code for controlling the applied voltage can be written in any conventional computer readable programming language such as assembly language, C, C++, and the like. Compiled object code or script is executed by the processor to perform the tasks identified in the program.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A separator comprising:
a vessel comprising a gas sparger;
a first inlet configured to receive a mixture of an aqueous solution of one or more lithium compounds and a solid carbon material;
a first outlet configured to transport a froth comprising the solid carbon material from the vessel to a collector; and
a second outlet configured to transport the aqueous solution out of the vessel.

2. The separator of claim 1, wherein the vessel further comprises an agitator.

3. The separator of claim 1, wherein the solid carbon material comprises graphite.

4. The separator of claim 1, wherein the aqueous solution comprises lithium bicarbonate.

5. The separator of claim 1, wherein the mixture of the aqueous solution and the solid carbon material comprises one or more solid impurities, and wherein the separator comprises a filter configured to (a) receive the aqueous solution and solid impurities from the second outlet, and (b) filter the solid impurities from the aqueous solution.

6. A method comprising:
receiving a mixture of an aqueous solution of one or more lithium compounds and solid carbon material;
forming a froth on the mixture, wherein the froth comprises the solid carbon material; and
separating the solid carbon material from the froth.

7. The method of claim 6, wherein the solid carbon material comprises graphite.

8. The method of claim 6, wherein the aqueous solution comprises lithium bicarbonate.

9. The method of claim 6, wherein the froth is formed by introducing a gas and/or agitating the mixture.

10. The method of claim 6, wherein the mixture of the aqueous solution and the solid carbon material comprises one or more solid impurities, and further comprising filtering the one or more solid impurities from the mixture of the aqueous solution.

11. A system comprising:
(a) a grinder configured to grind a solid mixture of lithium carbonate, lithium oxide, and a solid carbon material to form a ground solid mixture;
(b) an aqueous lithium compound generator configured to (i) receive the ground solid mixture produced by the grinder, and (ii) output a mixture of an aqueous solution of one or more lithium compounds and the solid carbon material; and
(c) a froth separator configured to (i) receive the mixture of the aqueous solution of the one or more lithium compounds and the solid carbon material, and (ii) output a froth comprising the solid carbon material.

12. The system of claim 11, wherein the solid carbon material comprises graphite.

13. The system of claim 11, wherein the aqueous solution comprises lithium bicarbonate.

14. The system of claim 11, wherein the froth separator further comprises an agitator and/or a gas sparger.

15. The system of claim 11, wherein the mixture of the aqueous solution and the solid carbon material comprises one or more solid impurities, and wherein the froth separator comprises a filter configured to (a) receive the mixture comprising the one or more solid impurities, and (b) filter the one or more solid impurities from the aqueous solution.

16-40. (canceled)
